(19) United States
(12) Patent Application Publication
(10) Pub. No.: US 2015/0313075 A1
(43) Pub. Date: Nov. 5, 2015

(54) Weed Removal and Plant Transplanting Tool

(71) Applicant: Thomas Carlino, San Jose, CA (US)

(72) Inventor: Thomas Carlino, San Jose, CA (US)

(21) Appl. No.: 14/696,461

(22) Filed: Apr. 26, 2015

Related U.S. Application Data
(60) Provisional application No. 61/988,317, filed on May 5, 2014.

(51) Int. Cl. A01B 1/16

(52) U.S. Cl. CPC A01B 1/16

(57) ABSTRACT

A high performance tool for weed removal and transplanting small plants comprises a blade, foot step and elongated handle. The blade is attached to one handle end and the foot step is attached to the blade at the handle end. The blade tip is driven into the earth near a plant root or transplant location with operator foot pressure on the foot step. The operator then pushes downward on the opposite handle end and the tool operates as a lever with fulcrum at blade or foot step contact with the earth surface, causing the blade tip to lift upward and remove a plant or soil portion. A narrow flat blade with sharpened tip presents a small profile for easy earth penetration. A long handle allows the operator to work from a beneficial standing position, and leverage produced by handle to blade relative length amplifies blade tip lifting force.

### CROSS-REFERENCE TO RELATED APPLICATIONS

This is a continuation application of Application No. 61/988,317 filed on 2014 May 5, a provisional application as identified in the accompanying Application Data Sheet.

### STATEMENT REGARDING FEDERALLY SPONSORED RESEARCH OR DEVELOPMENT

Not Applicable

### REFERENCE TO A SEQUENCE LISTING, A TABLE OR A COMPUTER PROGRAM LISTING COMPACT DISC INDEX

Not Applicable

### BACKGROUND OF THE INVENTION

This invention relates to weeding and transplanting tools, specifically to devices for use in removing a plant including root from the soil by penetration into the soil at the plant root, or preparing a transplant hole by removing a portion of soil by penetration into the earth at a transplant location.

### PRIOR ART

Open space restoration has become an activity of much interest due to increased awareness of disappearing wild lands and open spaces, and the degraded quality of many lands that have been designated as natural preserves. The lands are degraded because typical previous land uses, particularly farming and ranching, employed intensive transformation of the environment to support plants for direct human consumption and feeds for domesticated animals bred for human consumption or as materials for human manufactured products.

As such the native flora and fauna were regarded as useless clutter on the land and were destroyed wholesale in the transformation. A very undesirable consequence of the transformation was the introduction of various plant species, some intentionally, others unintentionally, from distant places that are in natural balance in their native environment but completely out of balance in the transformed environment. The imbalance is due to absence of bio-controls in the transformed environment that are naturally present in the native environment of the introduced species. In other words, nothing eats the introduced plants so they grow out of control and reproduce unchecked to form mono-cultures that exclude virtually all of the native species. The result is a completely out-of-balance ecosystem that desperately needs intervention to help restore the balance.

Examples of intentionally introduced species in North America are Fullers' Teasel, whose seed heads were formerly used for processing fibers such as wool into textile materials, and Poison Hemlock as an ornamental. An example of an unintentionally introduced species as a contaminant in a different seed stock for food plants is Yellow Starthistle. These plants spread rapidly in massive numbers and form dense mono-cultures that exclude all other species not only by their sheer numbers and resource consumption but also sometimes by chemical means with herbicidal substances emitted from their roots as is characteristic of both Fullers' Teasel and Poison Hemlock.

So it has become imperative to remove the invasive species before native plant restoration can be accomplished successfully. Many methods have been tried and are currently in use including mechanical, chemical and fire controls. Some have been successful in varying extent and some have not.

The focus of this invention is on the mechanical means, particularly hand tools, of which there have been many varieties. Many of the previous hand tools were designed for similar purposes to that of this invention but not for use on as large of a scale. It can be surmised that most of them were not successful, as evidenced by the proliferation of such devices in patent history, yet with the obvious absence in the market at the present time of all but the most simple generic brute force tools such as picks and shovels that are the commonly preferred choice. But the simple generic tools require a great amount of manual labor to operate and usually deliver high impact shock and stress to the operator's muscles and skeletal joints, resulting in both short and long term harm to the physiology of the operator.

From analysis of why the more complex and specialized tools have failed to gain acceptance, a few general conclusions can be ascertained. Inadequate marketing could be one cause but is difficult to quantify. What remains is that a tool may look plausible on paper and in concept, but in practice lacks the performance, robustness or reliability demands of the large volume tasks characteristic of open space restoration. Generally there may be unfavorable characteristics that may seem insignificant at first, but prove to be gating factors once they are put to the test in the real world. Some such characteristics are discussed below.

### 1. Over-Specialization

A tool that is too specialized has limited versatility and inability to cope with a variable range of work site conditions as encountered in the relatively large and diverse expanses of open space preserves.

### 2. Tool Geometry

For digging tools, wide blades and tool heads such as those of typical shovels encounter too much resistance to earth penetration and attempt to move too much volume of soil. They therefore require too much power to operate, in excess of normal human capability. For tools that are designed primarily for striking such as picks, digging into soil requires far too many repeated strikes and delivers severe stress and shock to upper body muscles and joints.

### 3. Moving Parts

Moving parts are generally unsuitable for high volume digging use and harsh work site conditions. They may appear to be interesting and functionally useful features, but are subject to rapid degradation, impeded movement and eventual seizure due to soil and plant matter accumulation. Frequent maintenance, particularly thorough cleaning, is required to restore movement and is impractical since work sites generally lack even the most basic cleaning elements such as a viable water source. Also the highly abrasive soil components routinely encountered at such sites cause rapid wear, damage and failure at rotating, sliding or other movement contact points.

### 4. Handle Length

Short handles require bending over in uncomfortable positions or navigating on hands and knees on the ground for long periods of time to operate. Such unfavorable postures result in pain, fatigue and physical harm to the operator.

### 5. Component Sizing

Inappropriately sized components can result in insufficient strength and robustness to penetrate into the earth deep enough for large roots. They can suffer failure due to fatigue from the accumulated stress of highly repetitious operations.

### 6. Human Physiology Considerations

Some tools require most or all operational force to be exerted by the upper body, ignoring the legs which are the stronger part of the human physiology. This leads to harmful effects to the hands and arms, and joint stress and damage to the wrists, elbows and shoulders.

### 7. Over-Complexity

Too many components can result in excessive cost and difficulty for the manufacturing process, excessive potential points of failure, and burdensome maintenance. Simplicity is the key to reliability, maintainability, endurance and consistent performance.

All of the characteristics discussed above are not merely conjecture, but rather have been observed directly during development and testing of this and other related inventions alongside conventional tools. The evidence indicates that previous designs may be acceptable for occasional light duty home gardening tasks, but are impractical for the large scale heavy duty requirements of open space restoration projects.

The US Patent classes found to be the most relevant in the search for previous inventions with similar characteristics to this invention are 172/378, 172/380, 254/132, 294/50.5, and 294/50.6.

The following references are to previous patents that each exhibit at least one of the above mentioned unfavorable characteristics.

| US Patent Number | Date | Inventor | Class |
|---|---|---|---|
| 1,564,373 | Dec. 8, 1925 | Smith | 254/132 |
| 4,281,866 | Aug. 4, 1981 | Atcheson | 294/50.5 |
| 5,456,449 | Oct. 10, 1995 | Smith | 254/132 |
| 5,609,325 | Mar. 11, 1997 | DeArmond | 254/132 |
| 5,964,451 | Oct. 12, 1999 | Sudheimer | 254/132 |
| 6,138,769 | Oct. 31, 2000 | Breyer | 172/380 |
| 6,505,869 | Jan. 14, 2003 | Novotny | 294/50.6 |
| 6,758,459 | Jul. 6, 2004 | Heikkenen | 254/132 |
| 6,959,768 | Jan. 1, 2005 | Casillas | 172/378 |
| 7,845,696 | Dec. 7, 2010 | Hatcher | 294/50.5 |

### SUMMARY OF THE INVENTION

The first focus of the invention is an improved manually operated tool for weed removal that increases operator efficiency to better cope with the typical high volumes of invasive weeds that need to be dealt with in degraded areas for open space restoration projects. On many occasions the only practical way to remove a weed is to uproot it by digging into the earth at the root. To that end, this invention provides an improved earth penetration means that requires significantly less strength and force to operate and is essentially impact-free compared to conventional general purpose digging tools such as shovels and picks. Combined with leverage provided by a long handle, very rapid high volume weed removal can be accomplished. Further, the tool operates effectively in virtually all soil conditions.

The second focus of the tool is for transplanting of small plants. The narrow blade can be inserted with precision into the earth beneath the root of a small plant and the handle leverage allows a portion of soil containing all of the plant root to be easily removed without damaging the plant. The plant with soil portion is then taken to a new location where the tool again is used to remove a similar sized portion of soil to prepare a hole into which the plant is placed. Preparing the hole at the new location is generally accomplished with just one operation of the tool and produces a hole sized properly for the plant with soil portion removed from the previous site. This greatly improves over previous methods. In contrast for example, a typical shovel head is too wide to focus on a single small plant and receives too much earth penetration resistance, so penetration deep enough into the soil to avoid damaging the root is difficult. Also the soil portion removed is much larger and heavier than necessary and difficult to work with. And for new transplant hole preparation, a typical tool such as an auger attached to an electric battery powered drill is difficult to control due to backlash from the twisting motion, troublesome to carry to a work site due to the weight of the drill and batteries, and sharply limited in operating time by battery charge capacity.

Additional benefits are greatly reduced operator fatigue and harmful upper body and lower back physical stress, characteristics commonly experienced with the excessive amount of energy expended and muscle and joint damaging shock routinely encountered with previous tools. Physical stress is particularly a concern for senior citizens, which I the inventor, as a senior citizen myself, am acutely aware of, having experienced first hand many of the troublesome consequences of aging. For many senior citizens in retirement, participation in such open space restoration activities is highly desired but often severely restricted due to the extra stress imposed by conventional tools upon their aging physiology. The tool provides a way for them to participate much more productively.

The invention accomplishes the goals with a leveraged flat narrow blade with a tapered tip that allows easy earth penetration due to small blade tip surface area, translating into large force per unit area with considerably reduced applied force by the operator. Additionally, a foot step allows for use of the foot and leg muscles to provide most of the power in an impact-free motion, sparing the upper body and lower back from stress and shock damage associated with conventional digging tools.

A long handle attached to the end of the blade provides leverage for amplified lifting force when the blade has penetrated into the earth. The handle may be composed of a variety of materials that provide a range of weight and strength balances depending on different use conditions. For example a wood handle combines low weight and moderate strength adequate for small to moderate side plants, in consistently soft soil or even for lighter home gardening use. In contrast a steel handle combines greater weight and high strength needed for heavy duty use with large plants or hard soil. Even in a heavy duty implementation the invention is light enough to carry easily to a work site and operate effectively for long periods of time.

The net effect of the above stated features is to allow the operator to remain in a comfortable standing position most of the time and move from one plant to the next very quickly. In contrast other tools subject the operator to the discomfort and wasted time and energy of unfavorable postures including crouching, bending over, navigating along the ground on hands and knees, or constantly shifting from one unfavorable posture to another.

Additional beneficial features are that the components of the tool can be attached with standard removable nut and bolt hardware so that worn or damaged components are easily replaceable by the operator, and different handles can be exchanged to accommodate varying work site conditions without having to acquire a complete new tool for each situation. Consequently the overall cost of ownership and maintenance of the tool is economically advantageous. Less materials need to be consumed, and all discarded parts, except perhaps wooden handles, can be recycled, minimizing overall environmental impact. Attention to these areas of concern is conspicuously absent in previous inventions.

### BRIEF DESCRIPTION OF DRAWINGS

FIG. 1 shows a perspective left front view of a tool according to the invention.

FIG. 2 shows a detail view of the handle of such tool as in FIG. 1.

FIG. 3 shows a detail view of the blade of such tool as in FIG. 1.

FIG. 4 shows a detail view of the foot step of such tool as in FIG. 1.

FIG. 5 shows a detail view of the head of such tool as in FIG. 1 with blade tip near a plant at the earth surface.

FIG. 6 shows a detail view of the head of such tool as in FIG. 1 with blade penetrating into the earth near a plant.

FIG. 7 shows a detail view of the head of such tool as in FIG. 1 lifting a plant with root out of the earth.

### LIST OF REFERENCE NUMERALS

1 handle
2 blade
3 foot step
4 blade to handle attachment hardware
5 foot step to handle attachment hardware
6 plant rosette
7 plant root
8 earth
10 holes in handle for blade attachment
20 blade tip
21 holes in blade for attachment to handle
22 holes in blade for foot step attachment
30 holes in foot step for attachment to blade

### DESCRIPTION OF THE INVENTION

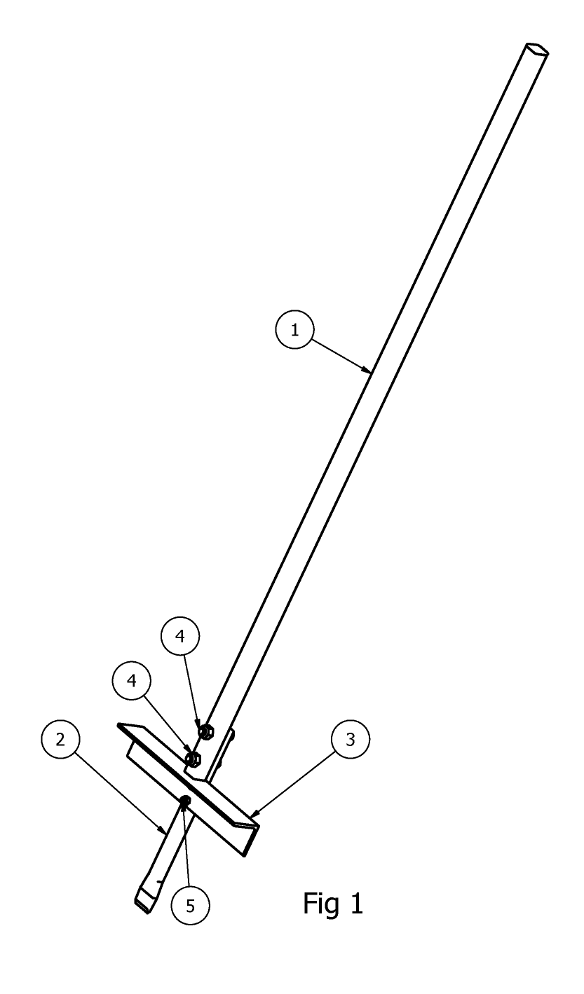

FIG. 1 shows a perspective left front view of a tool according to the invention. The tool in this embodiment comprises handle 1, blade 2, foot step 3 and attachment hardware 4 and 5.

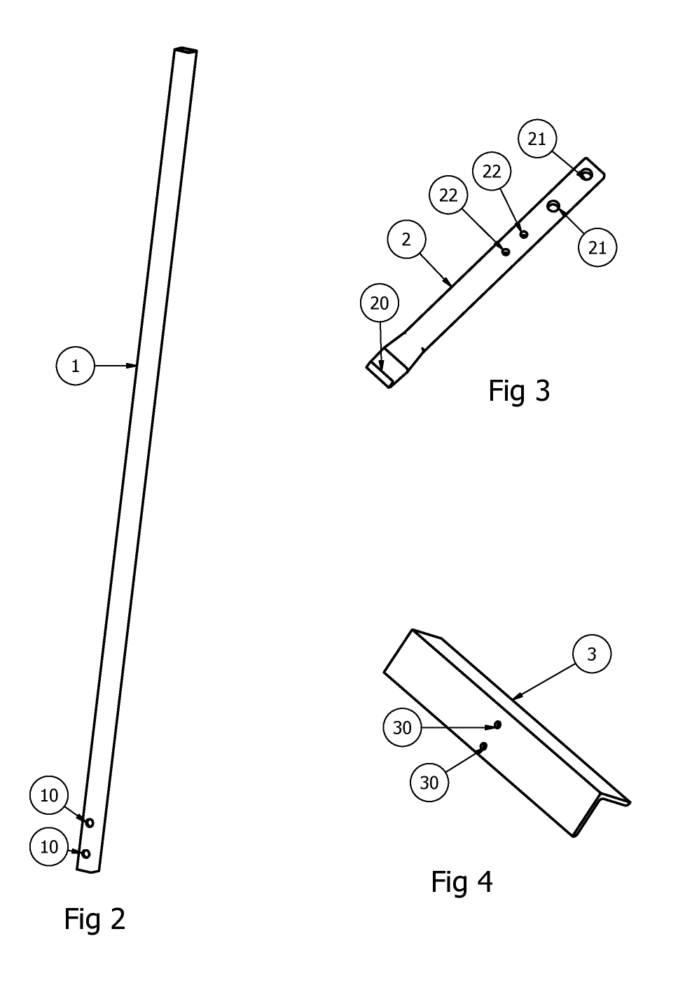

Handle 1 (FIG. 2) is a typical garden tool type handle composed of any suitable material including but not limited to wood, metal or fiberglass, approximately 4 feet in length and 1 inch in diameter. Holes are drilled near the bottom end of handle 1 for attachment of blade 2 with standard nut and bolt hardware 4. More than one attachment point is necessary for a stable rigid attachment of the blade length parallel to the handle length, and two points about two inches apart are sufficient for that purpose.

Blade 2 (FIG. 3) is a flat straight metal bar approximately 1 foot long by 1 inch wide by ⅜ inch thick. Blade tip 20 is wedge shaped and hardened for ruggedness and effective earth penetration. Holes 21 at the blade end opposite to tip 20 are for attachment to handle 1, and holes 22 near the middle part of blade 2 are for attachment of foot step 3.

Foot step 3 (FIG. 4) is composed of a right angle profile metal bar measuring approximately 1 foot long by 2 inches wide per side. Thickness of the material is selected to achieve sufficient strength to support most of the body weight of an average adult human and is dependent on the type of metal used. Aluminum and steel are the two most common and reasonable cost metals available. Standard aluminum extruded angle 2 inch by 2 inch by 3/16 inch is preferred as it is commonly available, has sufficient strength, large surface area and is lighter weight than steel. Holes 30 are placed so that foot step 3 attaches with length perpendicular to blade 2 length using standard nut and bolt hardware. More than one attachment point is needed for a stable rigid attachment to blade 2 and two attachment points about 1 inch apart are sufficient for that purpose.

### OPERATION OF THE INVENTION

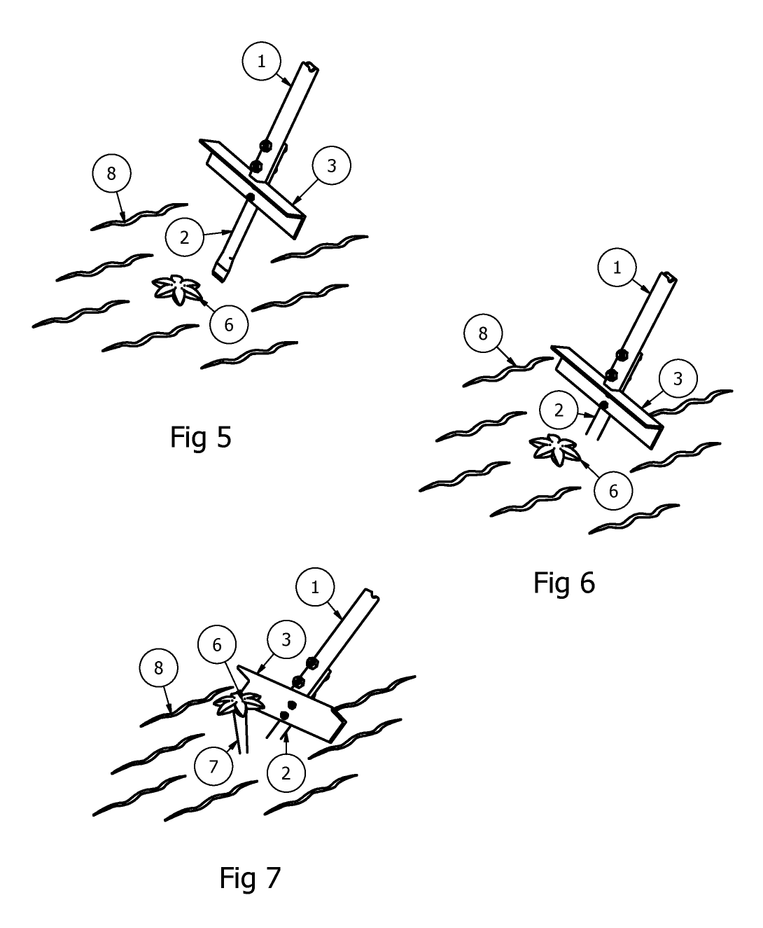

Operation of the tool is in three steps. First the tool is placed within a few inches of a plant or at a transplant hole location with blade tip 20 at earth 8 surface (FIG. 5) and with blade 2 and handle 1 at an angle relative to earth 8 surface, the angle being optimally about 45 to 60 degrees. Wavy lines 8 below the tool represent earth 8 surface with a plant rosette 6 visible above earth 8 surface and plant root 7 concealed below earth 8 surface. The view with rosette 6 is one example scenario and does not imply a limitation to only the rosette stage of plant growth. The tool works equally well on plants alive or dead, and at any growth stage with included stems, leaves, seed heads, etc.

Second, the operator applies pressure toward blade tip 20 with one foot on either the left or right side of foot step 3 while steadying handle 1 or rocking it front-to-back or side-to-side with hand and arm motion until blade 2 penetrates sufficiently into earth 8 (FIG. 6). The optimal depth of blade 2 penetration into earth 8 varies from typically about half the length of blade 2 down to the point where foot step 3 is in contact with earth surface 8 and prevents further penetration of blade 2. For weed removal, contact of blade tip 20 with plant root 7 is the preferred goal, but depending on soil conditions it is generally sufficient for blade tip 20 to be as much as a few inches away from plant root 7 for adequate performance. For transplanting plant removal, penetration of blade tip 20 below plant root 7 without direct root 7 contact is the preferred goal to avoid damaging the root.

Third, the operator asserts downward force on the end of handle 1 opposite to the blade (FIG. 7) with hand and arm motion. The downward motion of handle 1 causes the back surface of blade 2 or foot step 3 to serve as a fulcrum against earth 8, lifting blade tip 20 upward toward earth 8 surface. The length of handle 1 plus length of blade 2 above earth 8 surface relative to length of blade 2 penetrating below earth surface 8 provides leverage for blade 2 to push upward on plant root 7 and earth 8 with amplified force. The narrow width of blade 2 relative to conventional hand tools such as a shovel concentrates the force into a small area. Consequently the achieved high force per unit area compels blade tip 20 to lift upward very efficiently so that plant root 7, a portion of earth 8 or both together are forcibly separated and lifted upward from earth 8 with ease. A plant thus removed can then be handled as desired by the operator for disposal or transplanting, or a soil portion removed for transplant hole preparation can be set aside.

All of the motions required for operation of the tool are smooth and steady so stress and impact to the operator characteristic of conventional tools are mostly eliminated.

### SEQUENCE LISTING

Not Applicable

As noted in the Specification, the present invention is an implement intended to manually remove unwanted weeds from the earth and to transplant small plants. The present invention should not be considered limited to the particular examples described above, but rather should be understood to cover all aspects of the invention as fairly set out in the attached claims. For example, while suitable materials, such as an aluminum foot step and the like have been disclosed in the above discussion, it should be appreciated that these are provided by way of example and not of limitation as a number of other materials, dimensions and so forth may be used without departing from the invention. Various modifications as well as numerous structures to which the present invention may be applicable will be readily apparent to those of skill in the art to which the present invention is directed upon review of the present specifications. The claims are intended to cover such modifications and structures.

I claim:

1. A tool for removing plants including the root from the earth and for preparing holes for transplanting small plants using applied leverage of the blade with the blade penetrating into the earth near a plant root or in contact with it or at the transplanting location comprising:
a) A blade formed from a flat metal bar with one end tapered to a hardened sharp tip.
b) An elongated handle attached to the blade at the end of the blade opposite to the tapered tip, with handle length parallel to blade length.
c) A large flat surface area foot step attached to the blade near the handle attachment point, with foot step length perpendicular to the handle and blade length and extending to both sides of the handle and blade width.

2. The implement of claim 1, wherein the blade, handle and foot step may all be attached together with standard removable hardware so that all of the components may be individually replaceable.

3. The implement of claims 1 and 2, wherein the individual components may be merged together into various combinations of composite components or a single unified whole by casting or other manufacturing means, such as a blade and foot step merged into a single forged head component attached to a handle component.
